(19) United States
(12) Patent Application Publication
(10) Pub. No.: US 2016/0042278 A1
(43) Pub. Date: Feb. 11, 2016

(54) PREDICTIVE ADJUSTMENT OF RESOURCE REFRESH IN A CONTENT DELIVERY NETWORK

(71) Applicant: International Business Machines Corporation, Armonk, NY (US)

(72) Inventors: Aaron K. Baughman, Silver Spring, MD (US); Brian W. Jensen, Raleigh, NC (US); Mauro Marzorati, Lutz, FL (US)

(21) Appl. No.: 14/452,769

(22) Filed: Aug. 6, 2014

(51) Int. Cl. G06N 5/04; H04L 29/06; G06N 7/00

(52) U.S. Cl. CPC G06N 5/04; G06N 7/005; H04L 67/42

(57) ABSTRACT

A set of features is identified in a resource provided from a Content Delivery Network (CDN), a feature causing a first information available in the resource at a first time to change to a second information in the resource at a second time responsive to an event. A set of weights is determined corresponding to the set of features. A weight is related to a corresponding feature in the set of features. Using the set of weights and the set of features to compute an entropy comprising a probability that the resource is going to change. Using the entropy, a stale probability is computed, comprising a probability that an outdated version of the resource is going to be served from a cache in the CDN at the second time. A refresh information is adjusted responsive to the stale probability exceeding a threshold probability.

### TECHNICAL FIELD

The present invention relates generally to a method, system, and computer program product for serving content in a data network. More particularly, the present invention relates to a method, system, and computer program product for predictive adjustment of resource refresh in a Content Delivery Network.

### BACKGROUND

Websites and other content providers often host the content and content delivery applications in data processing environments that offer scalability, reliability, and a desired level of performance in content delivery. For example, a website hosted in a cloud environment can expect increased resource allocation when the load on the web server exceeds a level of demand, so that the website continues to provide the performance and user experience that a user expects from the website.

Similarly, the web server can be configured for failover when a system or component fails, so that the website continues to deliver its content reliably to the users. When the website grows to provide more content, different content, or dynamic content, the content delivery applications behind the scene can be allocated more computing power to scale up the content delivery applications.

Content Delivery Network (CDN) is a configuration with similar objectives for content delivery. A CDN is a configuration of data processing system and data storage devices spread over a data network to afford a content delivery application the scalability, the reliability, and the performance metric that is desired by the content delivery application.

Typically, a content source provides the content to a CDN. The content may be dynamic, to wit, changing over time, such as periodically, sporadically, or upon the occurrence of certain events. A CDN comprises one or more caches where all or portions of the provided content are stored. A CDN cache may be physically located proximate to a location from where the demand for the cached portion of the content arises, thereby reducing a delay in the content delivery time and improving the performance of the content delivery. A cache may duplicate the content portion of another cache thereby improving the reliability of the content delivery. Multiple caches may store and deliver the same portion of the content thereby improving the load handling ability of the content delivery.

The caches in a CDN are organized in some hierarchy. An example CDN organization is a tree structure having a root node, one or more intermediate nodes or leaf nodes organized in one or more levels of the hierarchy spawning from the root node. The root node, the intermediate nodes, and the leaf nodes are CDN caches that obtain their content portions from a content source or other caches in the organization. Generally, any node in the CDN organization can serve or provide the content portion cached therein.

### SUMMARY

The illustrative embodiments provide a method, system, and computer program product for predictive adjustment of resource refresh in a Content Delivery Network. An embodiment includes a method for predictive adjustment of resource refresh in a Content Delivery Network (CDN). The embodiment identifies a set of features in a resource, the resource being provided from the CDN, a feature in the set of features causing a first information available in the resource at a first time to change to a second information in the resource at a second time responsive to an event. The embodiment determines a set of weights corresponding to the set of features, wherein a weight in the set of weight is related to a corresponding feature in the set of features. The embodiment computes, using the set of weights and the set of features, an entropy, the entropy comprising a probability that the resource is going to change. The embodiment computes, using the entropy, a stale probability, the stale probability comprising a probability that an outdated version of the resource is going to be served from a cache in the CDN at the second time. The embodiment adjusts a refresh information responsive to the stale probability exceeding a threshold probability, wherein adjusting the refresh information changes at least one of the entropy and an other component used in computing the stale probability.

Another embodiment includes a computer program product for predictive adjustment of resource refresh in a Content Delivery Network (CDN). The embodiment further includes one or more computer-readable tangible storage devices. The embodiment further includes program instructions, stored on at least one of the one or more storage devices, to identify a set of features in a resource, the resource being provided from the CDN, a feature in the set of features causing a first information available in the resource at a first time to change to a second information in the resource at a second time responsive to an event. The embodiment further includes program instructions, stored on at least one of the one or more storage devices, to determine a set of weights corresponding to the set of features, wherein a weight in the set of weight is related to a corresponding feature in the set of features. The embodiment further includes program instructions, stored on at least one of the one or more storage devices, to compute, using the set of weights and the set of features, an entropy, the entropy comprising a probability that the resource is going to change. The embodiment further includes program instructions, stored on at least one of the one or more storage devices, to compute, using the entropy, a stale probability, the stale probability comprising a probability that an outdated version of the resource is going to be served from a cache in the CDN at the second time. The embodiment further includes program instructions, stored on at least one of the one or more storage devices, to adjust a refresh information responsive to the stale probability exceeding a threshold probability, wherein adjusting the refresh information changes at least one of the entropy and an other component used in computing the stale probability.

Another embodiment includes a computer system for predictive adjustment of resource refresh in a Content Delivery Network (CDN). The embodiment further includes one or more processors, one or more computer-readable memories and one or more computer-readable tangible storage devices. The embodiment further includes program instructions, stored on at least one of the one or more storage devices for execution by at least one of the one or more processors via at least one of the one or more memories, to identify a set of features in a resource, the resource being provided from the CDN, a feature in the set of features causing a first information available in the resource at a first time to change to a second information in the resource at a second time responsive to an event. The embodiment further includes program instructions, stored on at least one of the one or more storage devices for execution by at least one of the one or more processors via at least one of the one or more memories, to determine a set of weights corresponding to the set of features, wherein a weight in the set of weight is related to a corresponding feature in the set of features. The embodiment further includes program instructions, stored on at least one of the one or more storage devices for execution by at least one of the one or more processors via at least one of the one or more memories, to compute, using the set of weights and the set of features, an entropy, the entropy comprising a probability that the resource is going to change. The embodiment further includes program instructions, stored on at least one of the one or more storage devices for execution by at least one of the one or more processors via at least one of the one or more memories, to compute, using the entropy, a stale probability, the stale probability comprising a probability that an outdated version of the resource is going to be served from a cache in the CDN at the second time. The embodiment further includes program instructions, stored on at least one of the one or more storage devices for execution by at least one of the one or more processors via at least one of the one or more memories, to adjust a refresh information responsive to the stale probability exceeding a threshold probability, wherein adjusting the refresh information changes at least one of the entropy and an other component used in computing the stale probability.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration where resource refresh can be adjusted in accordance with an illustrative embodiment;

FIG. 4 depicts a block diagram of examples of refresh information that can be predicatively adjusted in accordance with an illustrative embodiment; and

FIG. 5 depicts a flowchart of an example process for predictive adjustment of resource refresh in a Content Delivery Network in accordance with an illustrative embodiment.

### DETAILED DESCRIPTION

Within the scope of the illustrative embodiments, content or content portion of any type or size is designated a “resource.” A resource comprises one or more “pages.” A page of a resource comprises data that can be refreshed, updated, substituted, renewed, or otherwise manipulated over time, such as periodically, sporadically, or upon the occurrence of an event.

Within the scope of the illustrative embodiments, the CDN can comprise one or more caches. The resource is served or provided from a CDN, more particularly, from one or more caches in a CDN. The caches in a CDN can be of any suitable type, may be different from one another, and may provide the same or different resources.

Furthermore, the caches in a CDN according to the illustrative embodiments may be organized in any suitable manner, including but not limited to a tree-type hierarchical organization. For example, an organization within the scope of the illustrative embodiments is an interconnected node graph with no particular hierarchy where some nodes are connected with some other nodes in a 1-1, 1-n or n-m connectivity for data transfer. Another example organization of caches in a CDN contemplated within the scope of the illustrative embodiments is a flat CDN where one or more cache receives a resource from a content source or a resource repository. Many other cache organizations in a CDN are possible and the same are contemplated within the scope of the illustrative embodiments.

As an example, assume that a website serves information about tennis related things, people, and events. When a tournament is underway, e.g., Wimbledon, the website provides dynamic information such as score information, player statistics, match predictions, and the like.

The website comprises many sections, each section populated by one or more resource. The resources are served from a CDN. A resource may be dynamic, and change with events occurring in the tennis world. For example, as a match is being played in Wimbledon, the resources related to the scores and player statics are refreshed or updated with the current information.

The illustrative embodiments recognize that how and when a resource in a CDN is refreshed depends upon one or more refresh information. The refresh information according to the illustrative embodiments can take the form of a periodic refresh rate, an occasional or sporadic refresh criterion, an event trigger or subscription, or a combination of these and other conditions or rules for refreshing a target.

Furthermore, a target of a refresh according to a refresh information can be a page, a resource, a cache, a level of caches in a CDN organization, a subset of caches in a set of caches used in a CDN, or some combination thereof. For example, a refresh rate refreshes a target at a set period. A sporadic or occasional refresh criterion refreshes the target when the criterion is satisfied. An event triggered refresh refreshes the target when the event being watched or subscribed to occurs. Between refreshes, a target serves, or is, the most recently updated resource.

The illustrative embodiments recognize that while a CDN improves certain aspects of content delivery, serving resources from a CDN can also lead to serving stale content. The illustrative embodiments recognize that under certain circumstances, a source may contain, or may have supplied, a more current version of a resource than the version that continues to be served from a cache until a refresh according to the governing refresh information can occur. The circumstances include but are not limited to the refresh information governing the refreshing of a target, where in the CDN a particular resource is located, the characteristics of the cache where the resource is located, or a combination of these and other similar circumstances.

The illustrative embodiments recognize that as more resources are cached within the CDN, correspondingly less user traffic reaches the source of the resource. Consequently, the illustrative embodiments recognize that the possibility exists that at least some users will be served stale resource from at least some caches in the CDN. This possibility is exacerbated by the delays in the internal coordination, replication, synchronization, duplication, validation, and other CDN management activities that cost a finite amount of time before refresh activity can occur within the CDN.

The illustrative embodiments used to describe the invention generally address and solve the above-described problems and other problems related to providing resources from a CDN. The illustrative embodiments provide a method, system, and computer program product for predictive adjustment of resource refresh in a Content Delivery Network.

According to the illustrative embodiments, one factor in determining whether a user will receive a stale resource is the probability (p1) that the resource is located in a particular cache in the CDN. Another factor in determining whether a user will receive a stale resource is the probability (p2) that the resource is located in a particular cache at a particular level in the CDN. Another factor in determining whether a user will receive a stale resource is the resource entropy.

Resource entropy (or page entropy) according to the illustrative embodiments is a probability (p3) that the resource (or page) will change. Whether a resource or a page therein will change is dependent upon the features included in the resource. A feature of a resource is a variable that affects an information present in the resource. For example, consider again the example of the website serving tennis related information. Further assume that the section related to the matches occurring in Wimbledon is populated using a resource.

Such a resource has several features that cause the information in the resource to change. For example, the players currently playing the reported match are features, and different players (features) cause the information to change differently in the resource. Similarly, another example feature is the weather condition. The weather (feature) causes the information in the resource to change because, for example, a match may be delayed due to rain. Another example feature is the tennis statistics. The statistics (feature) causes the information in the resource to change because, for example, a player's performance in the reported match may cause the statistics to change.

The tennis related examples and the example features described above are not intended to be limiting on the illustrative embodiments. Using this disclosure, those of ordinary skill in the art will be able to conceive many other features specific to the resources in particular implementations, and the same are contemplated within the scope of the illustrative embodiments. For example, an implementation in the financial industry may include a resource whose features include stock performance statistics, news affecting a particular stock or a market, a product or person related to a stock or a market, and many others.

An embodiment computes p1, p2, and p3 for a given resource in a given CDN. The embodiment computes a probability (p4) that a user will receive a stale version of the resource from the given organization of the CDN.

An embodiment determines whether probability p4 exceeds a threshold probability. If the probability that the user will get a stale version of the resource exceeds the threshold, the embodiment causes a corrective action to occur in the CDN.

For example, one embodiment moves, copies, relocates, or otherwise causes a change in the location of the resource in the CDN, thereby affecting probabilities p1, p2, or both. A change in probabilities p1, or p2, or both results in a change in probability p4. When a change in probability p4 causes p4 to not exceed the threshold probability, the probability that the user will receive a stale version of the resource has been predictively reduced to an acceptable level (at most the threshold probability).

As another example, another embodiment reconfigures the resource, such as by adding, deleting, moving, or otherwise changing a page in the resource, thereby affecting the resource entropy p3. A change in resource entropy results in a change in probability p4. When a change in probability p4 causes p4 to not exceed the threshold probability, the probability that the user will receive a stale version of the resource has been predictively reduced to an acceptable level (at most the threshold probability).

As another example, another embodiment moves, copies, relocates, or otherwise causes a change in the location of the resource in the CDN, in combination with reconfiguring the resource, such as by adding, deleting, moving, or otherwise changing a page in the resource. The embodiment thus changes probabilities, p1 or p2, or p1 and p2, and p3. A change in some combination of p1, p2, and p3 results in a change in probability p4. When a change in probability p4 causes p4 to not exceed the threshold probability, the probability that the user will receive a stale version of the resource has been predictively reduced to an acceptable level (at most the threshold probability).

The example changes, manners of changing probabilities p1, p2, and p3 are described only as non-limiting examples. From this disclosure, those of ordinary skill in the art will be able to conceive other ways of changing one or more of these probabilities according to the given resource, the given CDN, and the given implementation, and the same are contemplated within the scope of the illustrative embodiments.

The illustrative embodiments are described with respect to certain resources, caches, CDN organizations, refresh information, resource sources, repositories, features, probabilities, rules, policies, algorithms, data processing systems, environments, components, and applications only as examples. Any specific manifestations of such artifacts are not intended to be limiting to the invention. Any suitable manifestation of data processing systems, environments, components, and applications can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

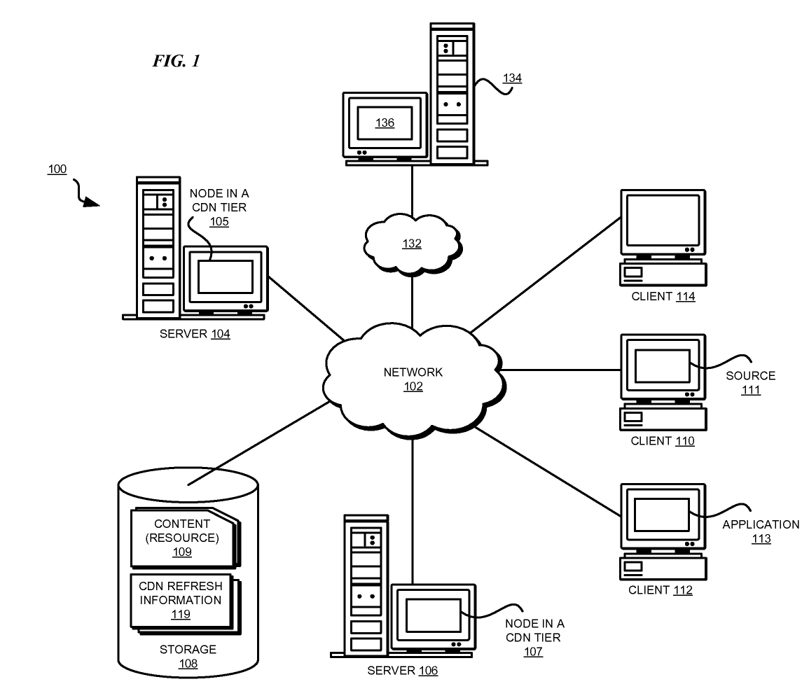

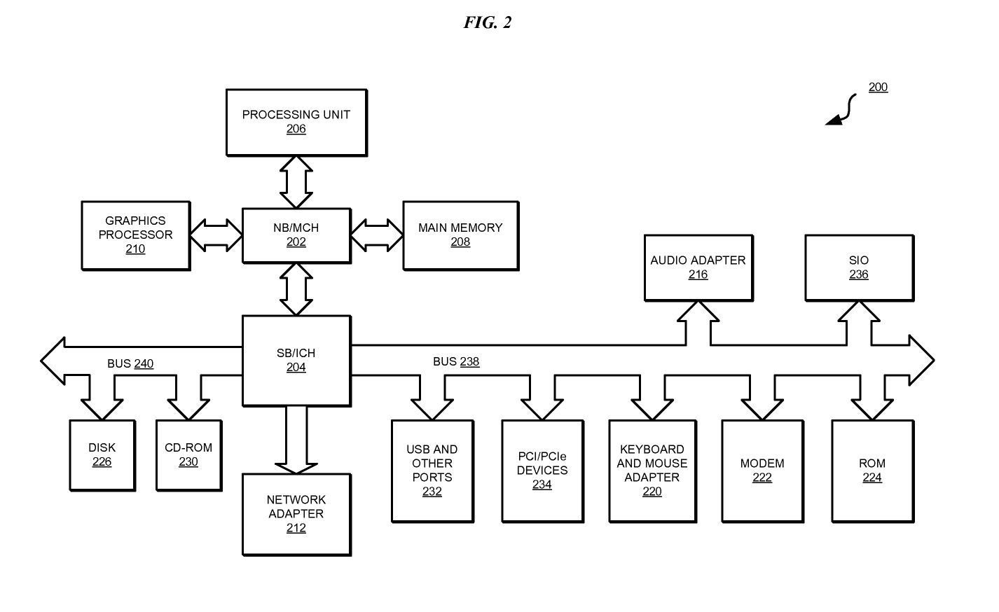

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments.

Application 136 in data processing system 134 accesses one or more resources over data network 132 from a CDN operating in network 102. For example, node 105 is a example cache in a cache tier in an example CDN hierarchy. Node 107 is another example cache in a cache tier in an example CDN hierarchy. Nodes 105 and 107 may or may not be in the same cache tier. Source 111 is the source of a resource in resources 109. For example, source 111 writes, stores, or supplies a resource in resources 111 in repository 108. Cache 105 serves a version of that resource to application 136. The resource is refreshed in cache 105 according to one or more refresh information in set 119 of CDN refresh information. Application 113 implements one or more embodiments described herein, such as to compute one or more probabilities, and predictively adjust one or more refresh information in set 119 using the computed probabilities.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments. Data processing system 200 is also representative of a data processing system or a configuration therein, such as data processing system 134 in FIG. 1 in which computer usable program code or instructions implementing the processes of the illustrative embodiments may be located. Data processing system 200 is described as a computer only as an example, without being limited thereto. Implementations in the form of data processing system 134, data processing system 104 hosting CDN node 105, data processing system 106 hosting node 107, or data processing system 111 operating as source 111 in FIG. 1 may modify data processing system 200 and even eliminate certain depicted components there from without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system such as AIX® (AIX is a trademark of International Business Machines Corporation in the United States and other countries), Microsoft® Windows® (Microsoft and Windows are trademarks of Microsoft Corporation in the United States and other countries), or Linux® (Linux is a trademark of Linus Torvalds in the United States and other countries). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle Corporation and/or its affiliates).

Instructions for the operating system, the object-oriented programming system, and applications or programs, such as refresh information 119 or application 113 in FIG. 1, are located on storage devices, such as hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

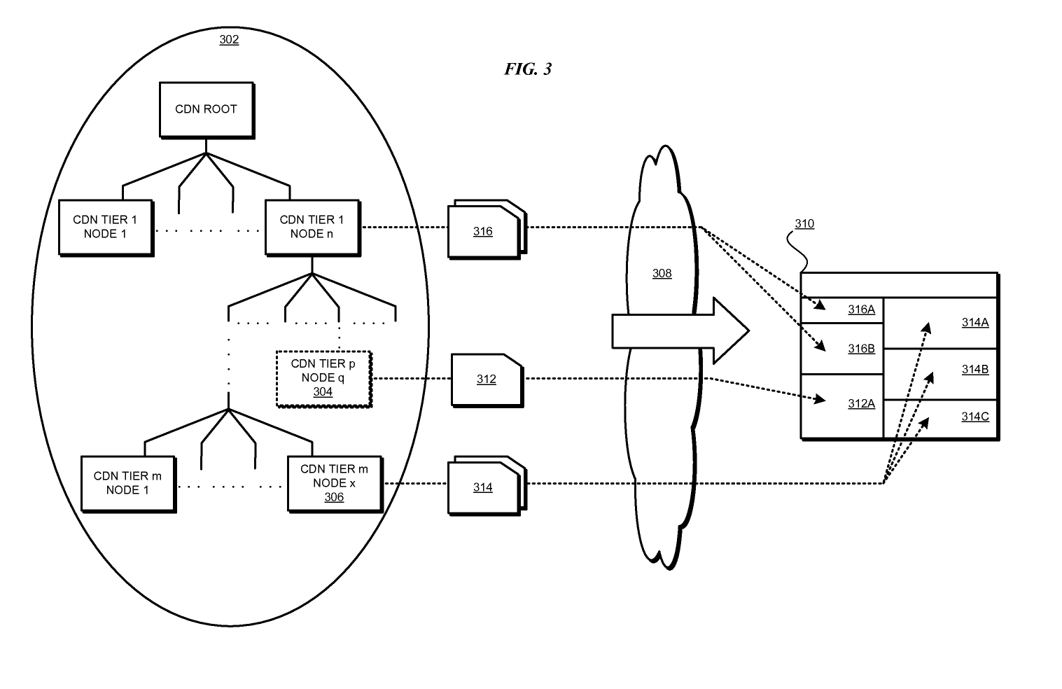

With reference to FIG. 3, this figure depicts a block diagram of an example configuration where resource refresh can be adjusted in accordance with an illustrative embodiment. CDN 302 comprises nodes, e.g., nodes 304 and 306, which are examples of nodes 105 and 107, respectively, in FIG. 1. Network 308 is an example of network 132 in FIG. 1. Application 310 is an example of application 136 in FIG. 1.

CDN 302 is depicted as a tree hierarchy only as an example. For example, CDN 302 includes a root node labeled “CDN root” which is a parent node of the nodes in the first tier of CDN nodes. For example, CDN root is the parent of nodes labeled “CDN tier 1 node 1” through “CDN tier 1 node n”. Any number of tiers or levels of nodes or caches can exist in CDN 302. For example, tier p includes node 304 labeled “CDN tier p node q” and perhaps other nodes at CDN tier p. Note that a node in CDN 302 can be a parent node or a child node. A child node can be a parent node to another node, or a leaf node that has no children nodes. Leaf nodes can appear anywhere in CDN 302 without any limitation. The root node can be a leaf node if CDN 302 comprises a single node or cache. Only as an example, nodes 304 and 306 are depicted as leaf nodes in CDN 302's tree hierarchy.

Resources 312 and 314, and any number of other resources are provided from CDN 302. Any node, whether a parent node, a child node, or a leaf node, can be configured to serve or provide a resource. For example, nodes 304 and 306 are children nodes and provide resources 312 and 314, respectively, but node “CDN tier 1 node n” is a parent node, and provides resource 316. Resources 312 and 314 are example resources in resources 109 in FIG. 1. As an example, source 111 in FIG. 1 supplies and refreshes one or more resources, e.g., resource 312, that are served from CDN 302 to application 310.

Only as an example and without implying a limitation thereto, assume that application 310, e.g., a browser, is presenting a content view to a user. The content view comprises several sections that are populated using several resources. For example, section 312A is populated using resource 312. Sections 314A, 314B, and 314C are populated using one or more instances of resource 314, different pages from an instance of resources 314, or a combination thereof. An instance of resources 314 may be a copy of the same resource or be a distinct resource. Similarly, sections 316A and 316B are populated using one or more instances of resources 316, different pages from an instance of resource 314, or a combination thereof.

Assume that source 111 may have updated information for resource 312 or may have refreshed resource 312 in repository 108 in FIG. 1. The illustrative embodiments recognize that operating CDN 302 without the benefit of predictive adjustment of resource refresh in a Content Delivery Network, there exists an above-threshold probability that node 304 may still serve a stale version of resource 312 at the time application 310 seeks to populate or repopulate section 312A.

Accordingly, the illustrative embodiments predictively adjust a resource refresh operation at node 304 such that the probability of serving a stale version of resource 312 is reduced to at most the threshold probability. Consequently, using an embodiment, such as by executing application 113 of FIG. 1 in conjunction with CDN 302, the probability that section 312A will receive the refreshed version of resource 312 from node 304 is increased as compared to the corresponding probability when an embodiment is not used with CDN 302.

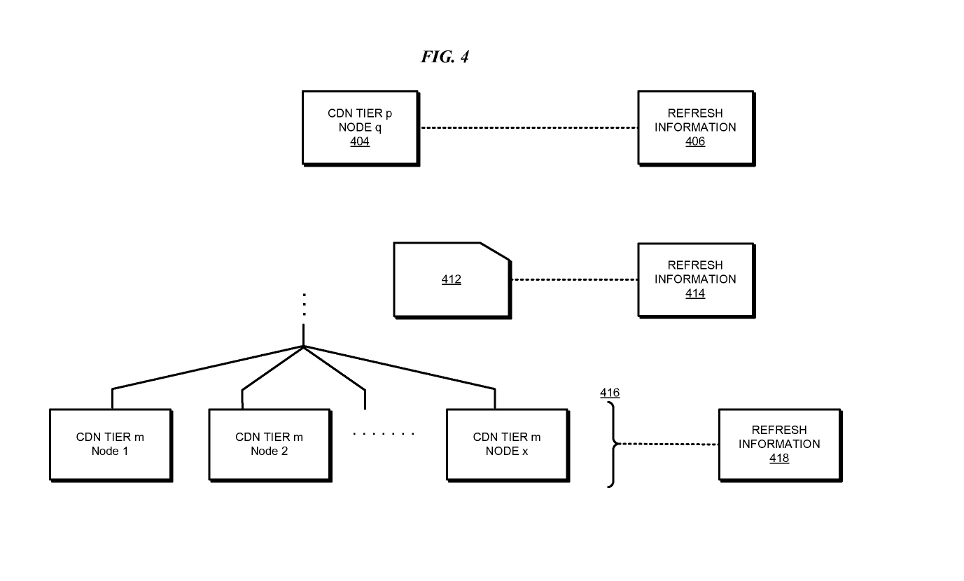

With reference to FIG. 4, this figure depicts a block diagram of examples of refresh information that can be predictively adjusted in accordance with an illustrative embodiment. Node 404 is an example of node 304 in FIG. 3. Resource 412 is an example of resource 312 in FIG. 3.

Refresh information 406 is an example of refresh information 119 in FIG. 1, and is associated with or governs the refresh of one or more resources being served from node 404. An embodiment, such as an embodiment implemented in application 113 in FIG. 1 and described elsewhere in this disclosure can predictively adjust refresh information 406 such that the probability that node 404 will serve a stale resource is reduced to at or below a threshold probability.

Refresh information 414 is an example of refresh information 119 in FIG. 1, and is associated with or governs the refresh of a particular resource, e.g., resource 412 that may be served from one or more caches or nodes in a CDN. An embodiment, such as an embodiment implemented in application 113 in FIG. 1 and described elsewhere in this disclosure can predictively adjust refresh information 414 such that the probability that a state version of resource 412 will be served from the one or more nodes in the CDN is reduced to at or below a threshold probability.

Refresh information 418 is an example of refresh information 119 in FIG. 1, and is associated with or governs the refresh of tier or level 416 of nodes in a given CDN, e.g., tier m to which node 306 belongs in CDN 302 in FIG. 3. An embodiment, such as an embodiment implemented in application 113 in FIG. 1 and described elsewhere in this disclosure can predictively adjust refresh information 418 such that the probability that one or more nodes in level 416 will serve one or more stale resource is reduced to at or below a threshold probability.

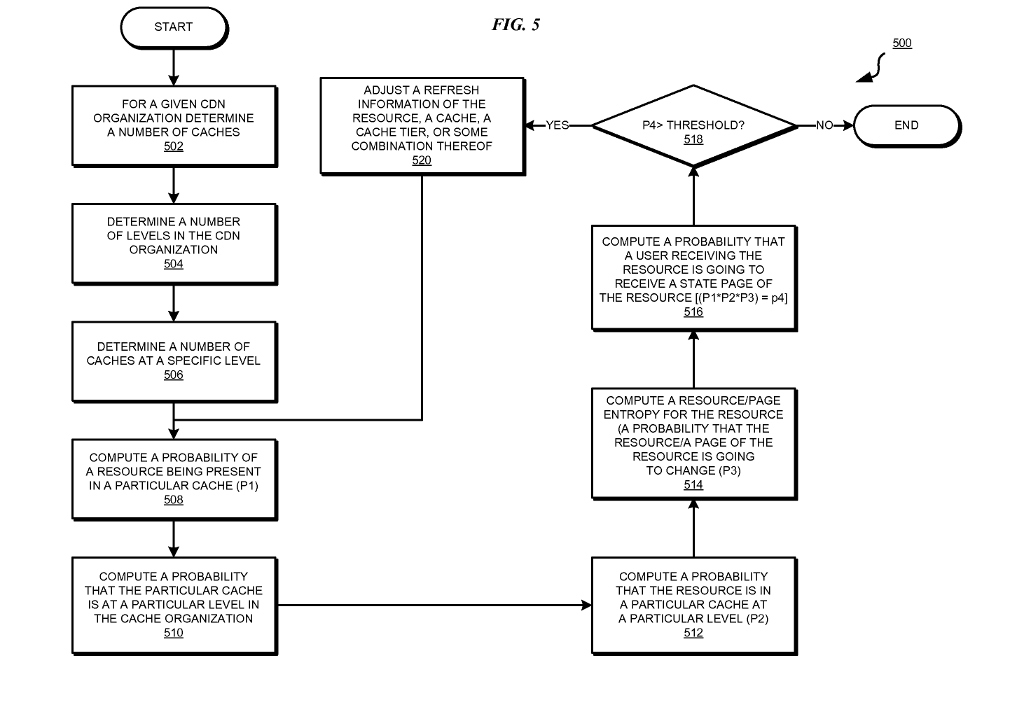

With reference to FIG. 5, this figure depicts a flowchart of an example process for predictive adjustment of resource refresh in a Content Delivery Network in accordance with an illustrative embodiment. Process 500 can be implemented in application 113 in FIG. 1.

For a given CDN organization, the application determines a number of caches in the CDN (block 502). For example, the application identifies each cache in the CDN with an index number, such as

Cₙ

where n is the index for cache C. The total number of caches, or the magnitude of the caches, N, is therefore

|cₙ|=N

The application determines a number of levels in the CDN organization (block 504). For example, within a tiered CDN, “1’ represents the cache levels. The summation of all caches at all levels in the CDN is therefore N.

$${\sum }_{l = 0}^{l} {2}^{l} = N$$

The application determines a number of caches at a specific level in the CDN organization (block 506). For example, the log base 2 of a total number of caches results in the total number of caches expected within a specific level “1”, to wit, cₗₙ—

log₂(cₗₙ)=l

The application computes a probability (p1) that a particular resource, whose probability of staleness is to be reduced to a threshold or below, is present in a particular cache (block 508). For example, assuming all caches are evenly distributed, the probability that resource x is within a particular one of N caches is 1/N.

P(x|N)=1/N

The application computes a probability that the particular cache is at a particular level in the CDN organization (block 510). Thus, by implication, the application computes the probability (p2) that the particular resource in the particular cache is at the particular level (block 512). For example, Assuming all caches are evenly distributed, the probability that resource x is within a particular cache in a particular level is—

P(x|N,l)=(N−2^{l}−1)/N

The application computes an entropy (p3) of the resource or a page of the resource (block 514). Assume that x₁, x₂, . . . , xₙ are n features in the resource that affect the resource's entropy. Further assume that each feature has a weight associated therewith, to wit, β₁, β₂, . . . , βₙ, respectively. Accordingly, in one example embodiment, the entropy p3 of the resource is computed as—

$$P ( {p}_{n} ) = \frac{1}{1 + {e}^{- ( {β}_{0} + {β}_{1} {x}_{1} + … + {β}_{n} {x}_{n} )}}$$

Where β₀ is a constant and pₙ is resource x or a page in resource x.

The application computes a probability (p4) that a stale version of the resource, resource x, is going to be delivered, such as to a requesting application (block 516). For example,

p4=p1*p2*p3

The application determines whether p4 exceeds a threshold (block 518). If p4 exceeds the threshold (“Yes” path of block 518), the application adjust at least one refresh information of the resource, a cache, a CDN level or cache tier, or some combination thereof (block 520). The application returns process 500 to block 508 to reevaluate p4. If p4 does not exceed the threshold (“No” path of block 518), the application ends process 500 thereafter.

Thus, a computer implemented method, system or apparatus, and computer program product are provided in the illustrative embodiments for predictive adjustment of resource refresh in a Content Delivery Network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for predictive adjustment of resource refresh in a Content Delivery Network (CDN), the method comprising:
identifying a set of features in a resource, the resource being provided from the CDN, a feature in the set of features causing a first information available in the resource at a first time to change to a second information in the resource at a second time responsive to an event;
determining a set of weights corresponding to the set of features, wherein a weight in the set of weight is related to a corresponding feature in the set of features;
computing, using the set of weights and the set of features, an entropy, the entropy comprising a probability that the resource is going to change;
computing, using the entropy, a stale probability, the stale probability comprising a probability that an outdated version of the resource is going to be served from a cache in the CDN at the second time; and
adjusting a refresh information responsive to the stale probability exceeding a threshold probability, wherein adjusting the refresh information changes at least one of the entropy and an other component used in computing the stale probability.

2. The method of claim 1, further comprising:
computing a cache probability, the cache probability comprising a probability that the resource is provided from the cache in the CDN, the other component comprising the cache probability; and
using the cache probability in computing the stale probability, wherein the adjusting the refresh information changes the cache probability.

3. The method of claim 1, further comprising:
computing a tier probability, the tier probability comprising a probability that the cache exists in a particular tier in the CDN, the other component comprising the tier probability; and
using the tier probability in computing the stale probability, wherein the adjusting the refresh information changes the tier probability.

4. The method of claim 1, the refresh information comprises:
information configured to refresh the resource responsive to the event.

5. The method of claim 1, the refresh information comprises:
information configured to refresh the cache responsive to the event.

6. The method of claim 1, the refresh information comprises:
information configured to refresh a tier of caches in the CDN responsive to the event, the tier including the cache.

7. The method of claim 1, the refresh information comprises:
information configured to refresh one of (i) the resource, (ii) the cache, and (iii) a tier of caches in the CDN, upon elapse of a period.

8. The method of claim 1, wherein the outdated version is a first version of the resource, wherein the resource has been updated to a second version by a source of the resource in a repository accessible from the CDN before the second time.

9. The method of claim 1, wherein the identifying, the computing using the set of weights and the set of features the entropy, the computing using the entropy the stale probability, are each performed relative to a portion of the resource, the portion comprising a page of the resource.

10. The method of claim 1, wherein the resource is a content.

11. The method of claim 1, wherein the method is embodied in a computer program product comprising one or more computer-readable tangible storage devices and computer-readable program instructions which are stored on the one or more computer-readable tangible storage devices and executed by one or more processors.

12. The method of claim 1, wherein the method is embodied in a computer system comprising one or more processors, one or more computer-readable memories, one or more computer-readable tangible storage devices and program instructions which are stored on the one or more computer-readable tangible storage devices for execution by the one or more processors via the one or more memories and executed by the one or more processors.

13. A computer program product for predictive adjustment of resource refresh in a Content Delivery Network (CDN), the computer program product comprising:
one or more computer-readable tangible storage devices;
program instructions, stored on at least one of the one or more storage devices, to identify a set of features in a resource, the resource being provided from the CDN, a feature in the set of features causing a first information available in the resource at a first time to change to a second information in the resource at a second time responsive to an event;
program instructions, stored on at least one of the one or more storage devices, to determine a set of weights corresponding to the set of features, wherein a weight in the set of weight is related to a corresponding feature in the set of features;
program instructions, stored on at least one of the one or more storage devices, to compute, using the set of weights and the set of features, an entropy, the entropy comprising a probability that the resource is going to change;
program instructions, stored on at least one of the one or more storage devices, to compute, using the entropy, a stale probability, the stale probability comprising a probability that an outdated version of the resource is going to be served from a cache in the CDN at the second time; and
program instructions, stored on at least one of the one or more storage devices, to adjust a refresh information responsive to the stale probability exceeding a threshold probability, wherein adjusting the refresh information changes at least one of the entropy and an other component used in computing the stale probability.

14. The computer program product of claim 13, further comprising:
program instructions, stored on at least one of the one or more storage devices, to compute a cache probability, the cache probability comprising a probability that the resource is provided from the cache in the CDN, the other component comprising the cache probability; and
program instructions, stored on at least one of the one or more storage devices, to use the cache probability in computing the stale probability, wherein the adjusting the refresh information changes the cache probability.

15. The computer program product of claim 13, further comprising:
program instructions, stored on at least one of the one or more storage devices, to compute a tier probability, the tier probability comprising a probability that the cache exists in a particular tier in the CDN, the other component comprising the tier probability; and
program instructions, stored on at least one of the one or more storage devices, to use the tier probability in computing the stale probability, wherein the adjusting the refresh information changes the tier probability.

16. The computer program product of claim 13, the refresh information comprises:
information configured to refresh the resource responsive to the event.

17. The computer program product of claim 13, the refresh information comprises:
information configured to refresh the cache responsive to the event.

18. The computer program product of claim 13, the refresh information comprises:
information configured to refresh a tier of caches in the CDN responsive to the event, the tier including the cache.

19. The computer program product of claim 13, the refresh information comprises:
information configured to refresh one of (i) the resource, (ii) the cache, and (iii) a tier of caches in the CDN, upon elapse of a period.

20. A computer system for predictive adjustment of resource refresh in a Content Delivery Network (CDN), the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to identify a set of features in a resource, the resource being provided from the CDN, a feature in the set of features causing a first information available in the resource at a first time to change to a second information in the resource at a second time responsive to an event;
program instructions, stored on at least one of the one or more storage devices for execution by at least one of the one or more processors via at least one of the one or more memories, to determine a set of weights corresponding to the set of features, wherein a weight in the set of weight is related to a corresponding feature in the set of features;
program instructions, stored on at least one of the one or more storage devices for execution by at least one of the one or more processors via at least one of the one or more memories, to compute, using the set of weights and the set of features, an entropy, the entropy comprising a probability that the resource is going to change;
program instructions, stored on at least one of the one or more storage devices for execution by at least one of the one or more processors via at least one of the one or more memories, to compute, using the entropy, a stale probability, the stale probability comprising a probability that an outdated version of the resource is going to be served from a cache in the CDN at the second time; and
program instructions, stored on at least one of the one or more storage devices for execution by at least one of the one or more processors via at least one of the one or more memories, to adjust a refresh information responsive to the stale probability exceeding a threshold probability, wherein adjusting the refresh information changes at least one of the entropy and an other component used in computing the stale probability.
